(19) United States
(12) Patent Application Publication
(10) Pub. No.: US 2003/0157826 A1
(43) Pub. Date: Aug. 21, 2003

(54) Cable connecting system

(76) Inventors: Michael Moreno, Bakersfield, CA (US); Jerry G. Wood, Bakersfield, CA (US)

Correspondence Address: Michael S. Neustel, Suite No. 4, 2534 South University Drive, Fargo, ND, 58103, US

(21) Appl. No.: 10/078,865

(22) Filed: Feb. 19, 2002

(51) Int. Cl. H01R 13/62

(52) U.S. Cl. 439/369

(57) ABSTRACT

A cable connecting system for removably securing a male coupler to a female coupler in a stable and orderly manner. The cable connecting system includes a first clamp having a first head, a second clamp having a second head, and a cable tie positionable within the first head and the second head. The second clamp is removably secured about the neck of a first connector that is attached to a second connector wherein the first clamp is removably secured about the neck of the second connector. The cable tie is extended through the second head until securely engaged within the first head of the first clamp thereby securing the connectors together in a stable and orderly manner that is unable to become loosened over time.

### BACKGROUND OF THE INVENTION

1. Field of the Invention

The present invention relates generally to cable connection devices and more specifically it relates to a cable connecting system for removably securing a male coupler to a female coupler in a stable and orderly manner.

2. Description of the Prior Art

Cable devices have been in use for years. Conventional cables have at least one connector attached to the distal end thereof. The connector plugs into a port or interface to connect one device to another. Most connectors are either “male” (containing one or more exposed pins) or “female” (containing holes in which the male connector can be inserted) though variations do exist on the market today. Cables with connectors are commonly utilized with devices such as but not limited to keyboards, computer mouse, monitors, USB (Universal Serial Bus) devices, speakers and various other devices.

Often times it is desirable to add an “extension cable” to an existing cable to allow for increased usage of the device. There are various extension cables currently available upon the market today that allow consumers to extend the effective length of their keyboard cable and other cables to the desired length. The extension cable is typically comprised of two connectors (one male, one female) that mate with the connector of cable the external device to be extended. The opposing connector of the extension cable is thereafter attached to the computer or other device thereby allowing the external device to function properly.

The main problem with conventional extension cable devices is that they are easily removed from the connector of the external device cable. To solve this problem many consumers utilized electrician tape to secure the connectors together which is not very secure and difficult to remove after applied to the connectors.

In addition, over periods of time, the pins within a male connector can become damaged or even broken because of the constant “reconnecting” of the extension cord. Also, valuable time is lost to the user who must constantly ensure that the extension cable is properly connected to the external device cable connector.

Examples of patented cable connecting devices which are illustrative of such prior art include U.S. Pat. No. 5,733,138 to Kramer; U.S. Pat. No. 5,336,107 to Sheryll; U.S. Pat. No. 5,104,335 to Conley et al.; U.S. Pat. No. 5,752,848 to Youngmark; U.S. Pat. No. 4,925,399 to Bosworth et al.; U.S. Pat. No. 4,690,476 to Morgenrath; U.S. Pat. No. 5,179,044 to Muromachi et al.; U.S. Pat. No. 5,328,384 to Magnuson; U.S. Pat. No. 5,876,234 to Hester; U.S. Pat. No. 5,913,693 to Fetterolf; U.S. Pat. No. 6,080,004 to Kovacik et al.; U.S. Pat. No. 6,135,803 to Kovacik et al.; U.S. Pat. No. 3,609,638 to Darrey; and U.S. Pat. No. 5,133,671 to Boghosian.

While these devices may be suitable for the particular purpose to which they address, they are not as suitable for removably securing a male coupler to a female coupler in a stable and orderly manner. Conventional cable connecting systems are not suitable for usage within the technology industries and can decrease worker productivity.

In these respects, the cable connecting system according to the present invention substantially departs from the conventional concepts and designs of the prior art, and in so doing provides an apparatus primarily developed for the purpose of removably securing a male coupler to a female coupler in a stable and orderly manner.

### SUMMARY OF THE INVENTION

In view of the foregoing disadvantages inherent in the known types of cable connectors now present in the prior art, the present invention provides a new cable connecting system construction wherein the same can be utilized for removably securing a male coupler to a female coupler in a stable and orderly manner.

The general purpose of the present invention, which will be described subsequently in greater detail, is to provide a new cable connecting system that has many of the advantages of the cable connectors mentioned heretofore and many novel features that result in a new cable connecting system which is not anticipated, rendered obvious, suggested, or even implied by any of the prior art cable connectors, either alone or in any combination thereof.

To attain this, the present invention generally comprises a first clamp having a first head, a second clamp having a second head, and a cable tie positionable within the first head and the second head. The second clamp is removably secured about the neck of a first connector that is attached to a second connector wherein the first clamp is removably secured about the neck of the second connector. The cable tie is extended through the second head until securely engaged within the first head of the first clamp thereby securing the connectors together in a stable and orderly manner that is unable to become loosened over time.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a cable connecting system that will overcome the shortcomings of the prior art devices.

A second object is to provide a cable connecting system for removably securing a male coupler to a female coupler in a stable and orderly manner.

Another object is to provide a cable connecting system that may be easily removed at anytime without damaging the connectors.

An additional object is to provide a cable connecting system that is easy to install for most users.

A further object is to provide a cable connecting system that does not require tools to utilize.

Another object is to provide a cable connecting system that reduces damage to connectors over extended periods of time.

A further object is to provide a cable connecting system that encourages consumers to utilize extension cords with their electronic devices without fear of accidents occurring.

Another object is to provide a cable connecting system that may be utilized with various designs, sizes and structures of cable systems available on the market.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention securing a male connector to a female connector.

FIG. 2 is an exploded upper perspective view of the present invention with respect to a female connector and a male connector.

FIG. 3 is a top view of the present invention securing a male connector to a female connector.

FIG. 4 is an exploded top view of the present invention with respect to a male connector and a female connector.

FIG. 5 is a front view of the first clamp that is similar in structure to the second clamp.

FIG. 6 is an upper perspective view of the first clamp that is similar to the second clamp.

FIG. 7 is a front view of an alternative embodiment of the first and second clamps having an opposing head for allowing the attachment of two cable ties.

FIG. 8 is a top view of the first clamp that is similar to the second clamp.

FIG. 9 is a side view of the first clamp that is similar to the second clamp.

### DESCRIPTION OF THE PREFERRED EMBODIMENT

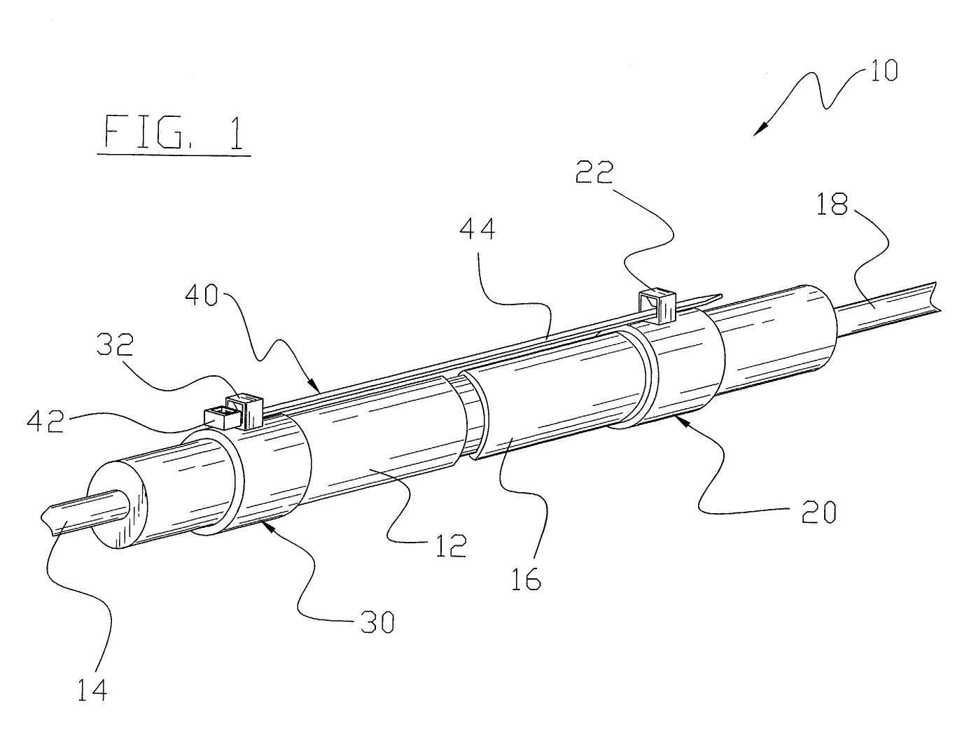

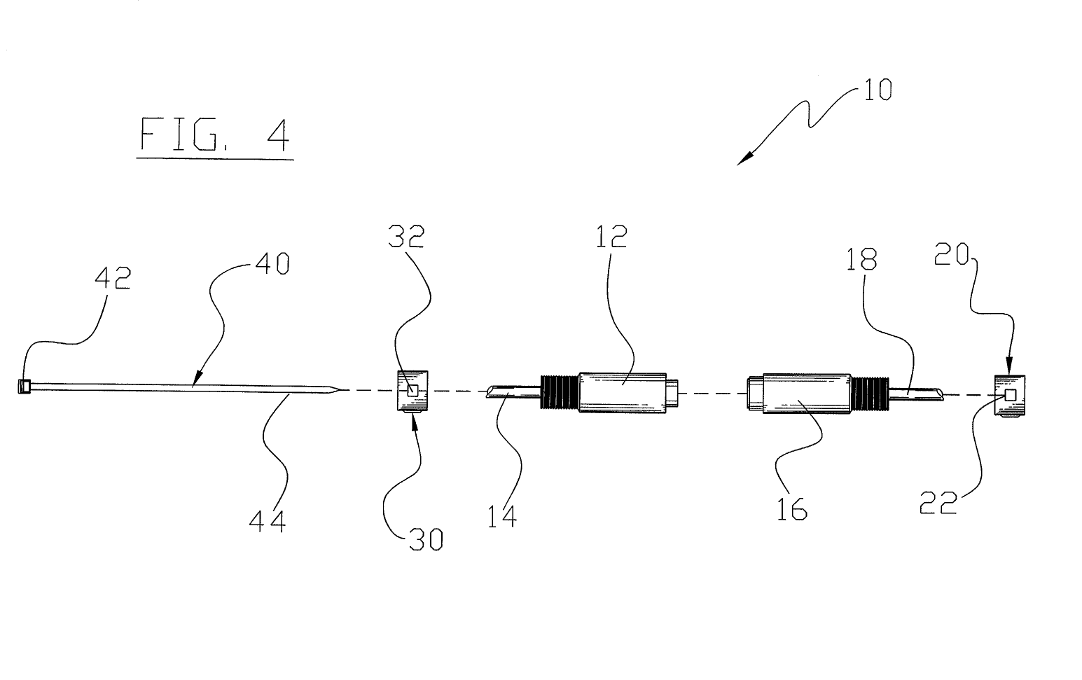

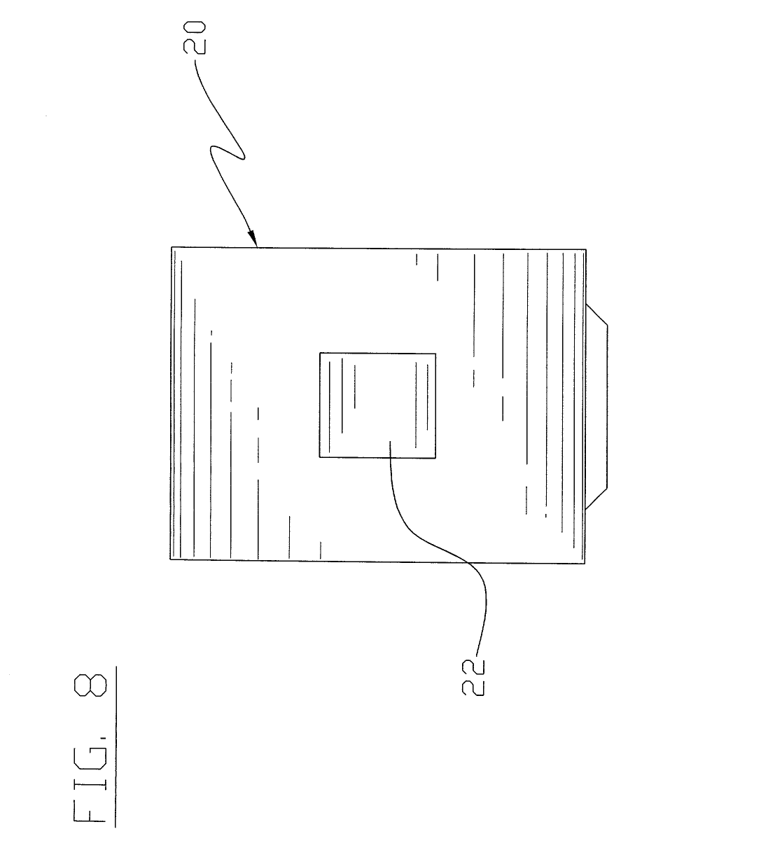

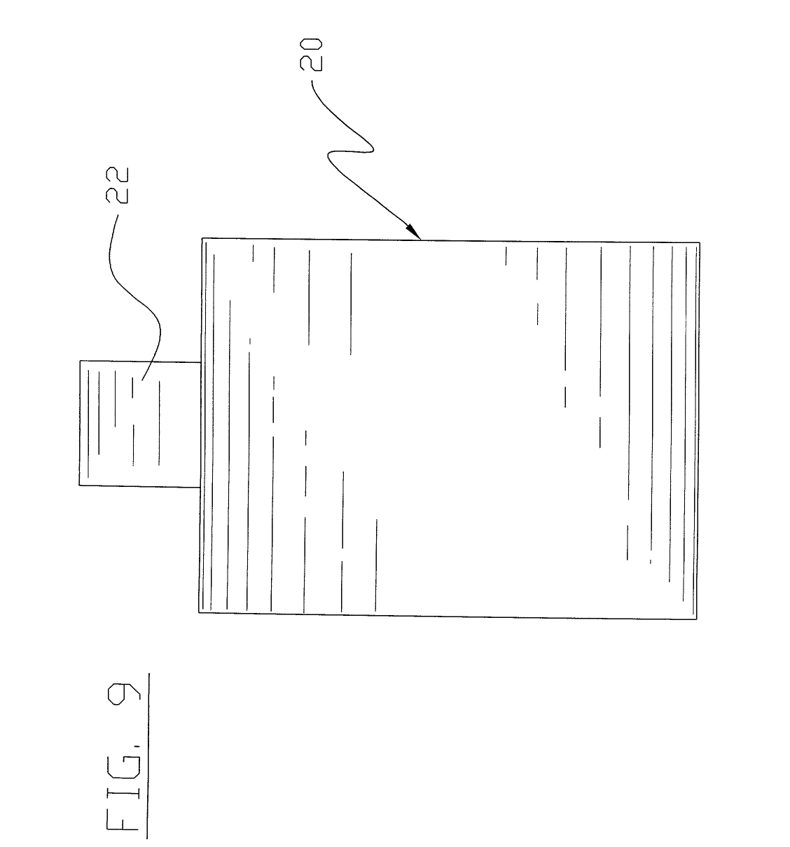

Turning now descriptively to the drawings, in which similar reference characters denote similar elements throughout the several views, FIGS. 1 through 9 illustrate a cable connecting system 10, which comprises a first clamp 20 having a first head 22, a second clamp 30 having a second head 32, and a cable tie 40 positionable within the first head 22 and the second head 32. The second clamp 30 is removably secured about the neck of a first connector 12 that is attached to a second connector 16 wherein the first clamp 20 is removably secured about the neck of the second connector 16. The cable tie 40 is extended through the second head 32 until securely engaged within the first head 22 of the first clamp 20 thereby securing the connectors together in a stable and orderly manner that is unable to become loosened over time.

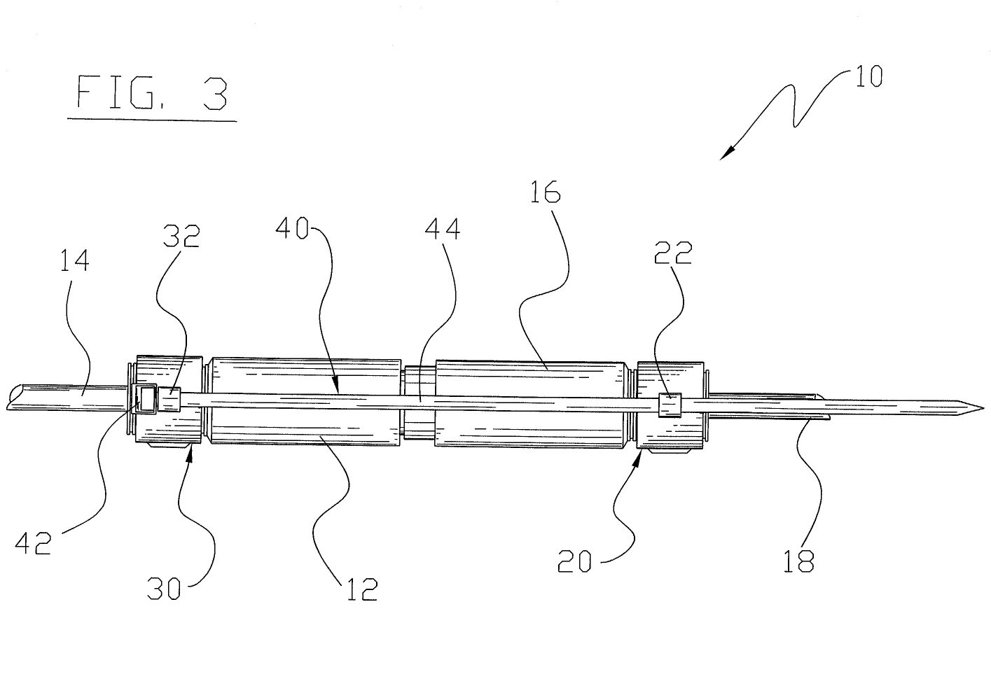

As shown in FIGS. 1 through 4 of the drawings, the first connector 12 and the second connector 16 have similar structure. The connectors 12, 16 have opposing connecting structures (i.e. male-female) that allow the connectors 12, 16 to be connected to one another as shown in FIGS. 1 and 3 of the drawings.

Each of the connectors 12, 16 is comprised of a body portion along with a tapered neck portion. It can be appreciated that some conventional connectors do not have a tapered neck portion. The first connector 12 is connected to the main cable 14 that is typically connected to an external device (e.g. mouse, keyboard, monitor, etc.). The second connector 16 is connected to the extension cable 18 that is desired to lengthen the effective length of the main cable 14. Since cables, extension cables 18 and connectors are readily apparent to one skilled in the art, no further discussion will be made regarding these structures.

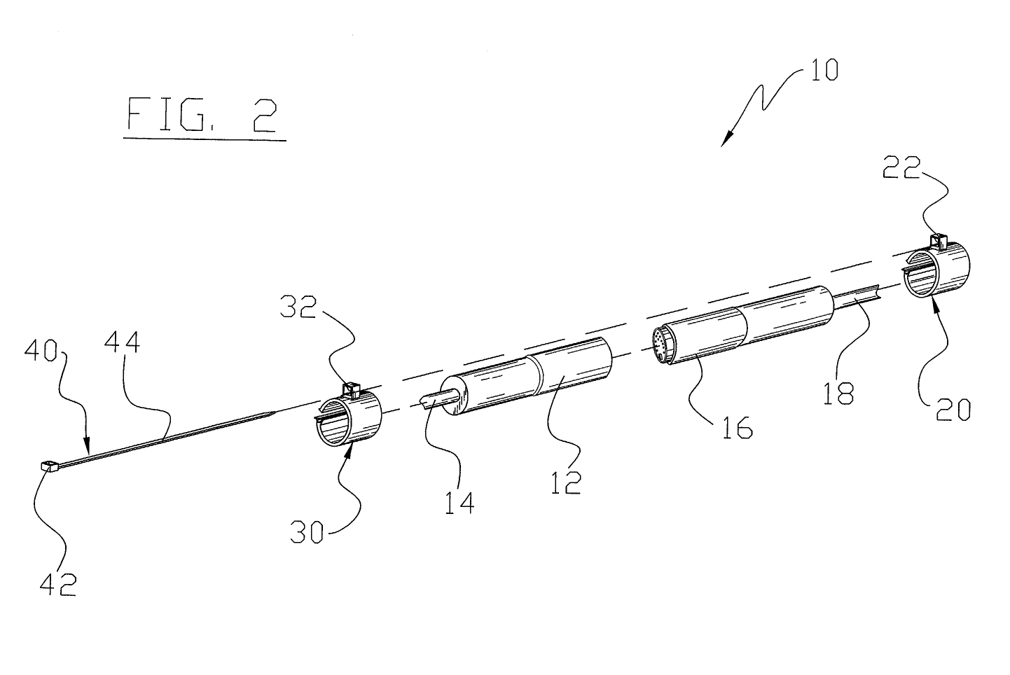

As best shown in FIG. 2 of the drawings, the first clamp 20 is similar in shape and structure to the second clamp 30. Since the second clamp 30 is similar in structure to the first clamp 20, the first clamp 20 will be mainly discussed with only a brief discussion of the second clamp 30 which is readily apparent from the figures and the description of the first clamp 20.

Both clamps 20, 30 are positionable about the tapered portion of the connectors 12, 16 as shown in FIGS. 1 and 3 of the drawings. It can be appreciated that the clamps 20, 30 may be attached to the body of the connectors 12, 16 or the cables 14, 18 in front of the connectors 12, 16. The clamps 20, 30 may have various sizes to accommodate various sizes of connectors 12, 16 and/or cables 14, 18.

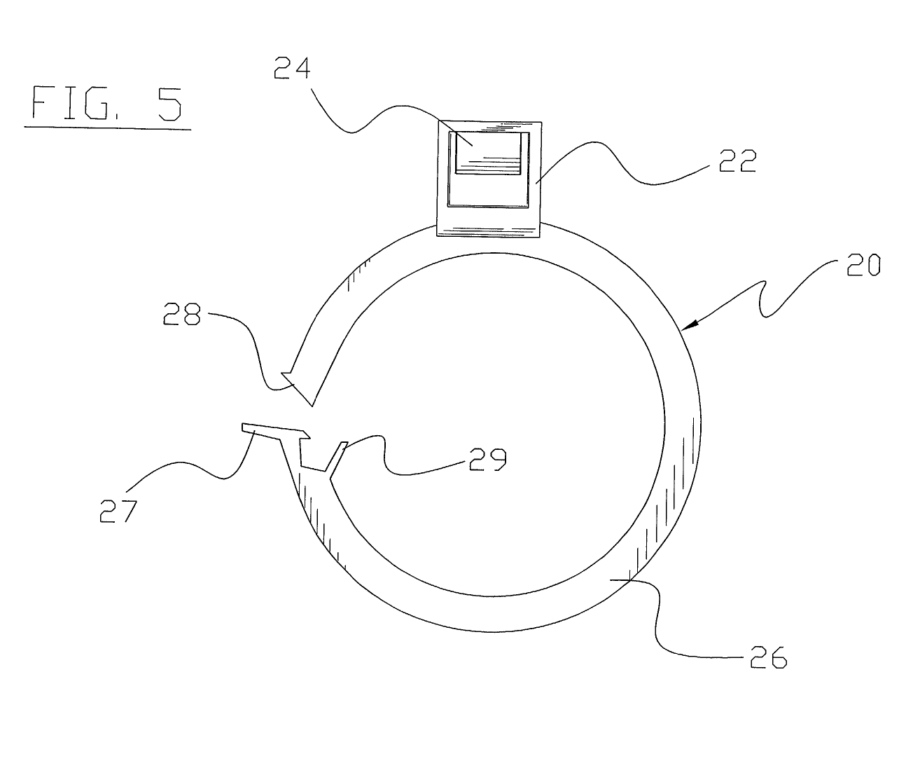

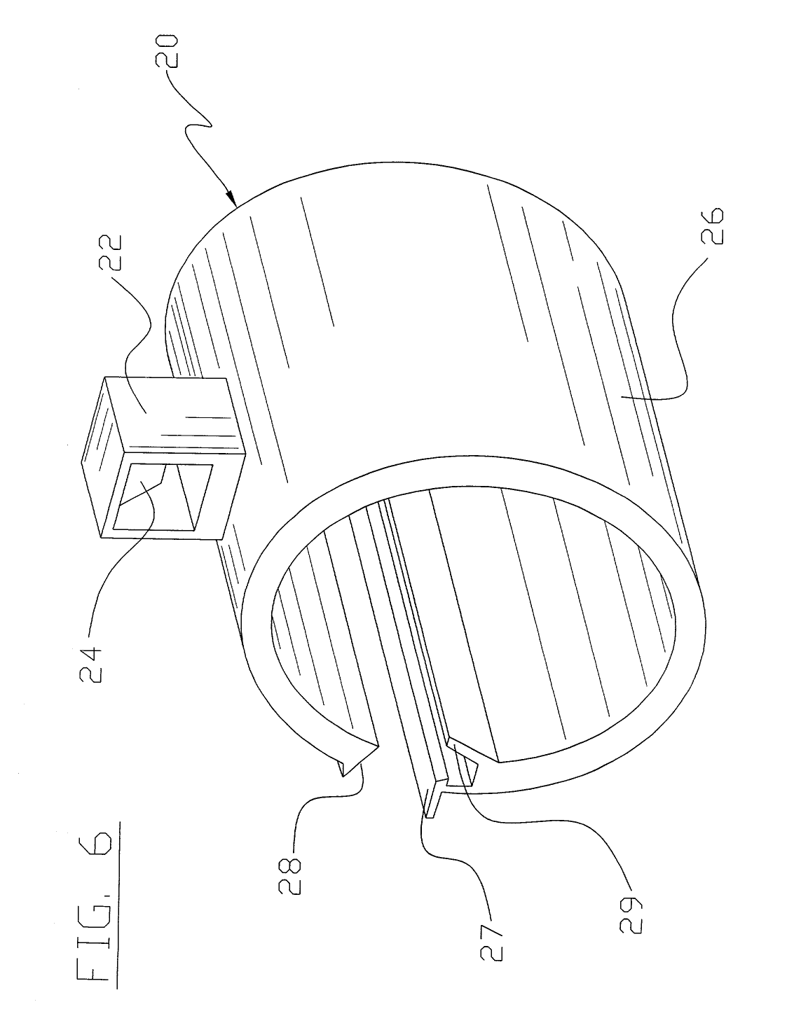

As best shown in FIG. 6 of the drawings, the first clamp 20 is comprised of a first body 26 have a looped structure with a center bore for receiving the connector 12, 16 or the cable 14, 18. The first body 26 has a first retaining end 29 and a first handle 27 at a distal end thereof as best shown in FIG. 6 of the drawings. The first body 26 includes first end 28 opposite of the first retaining end 29. The first retaining end 29 and first handle 27 are formed for catchably receiving the first end 28 as best shown in FIGS. 5, 6 and 7 of the drawings. The first handle 27 allows for the connecting and the separation of the first retaining end 29 and the first end 28.

As further shown in FIGS. 1 through 9 of the drawings, a first head 22 is attached to the first body 26 for receiving the cable tie 40. The first head 22 includes a first receiving slot 24 as best illustrated in FIGS. 5 and 6 of the drawings. The first receiving slot 24 is formed for catchably receiving the elongate body 44 of the cable tie 40. The first receiving slot 24 is aligned parallel to the bore within the first body 26 as further shown in FIGS. 5 and 6 of the drawings.

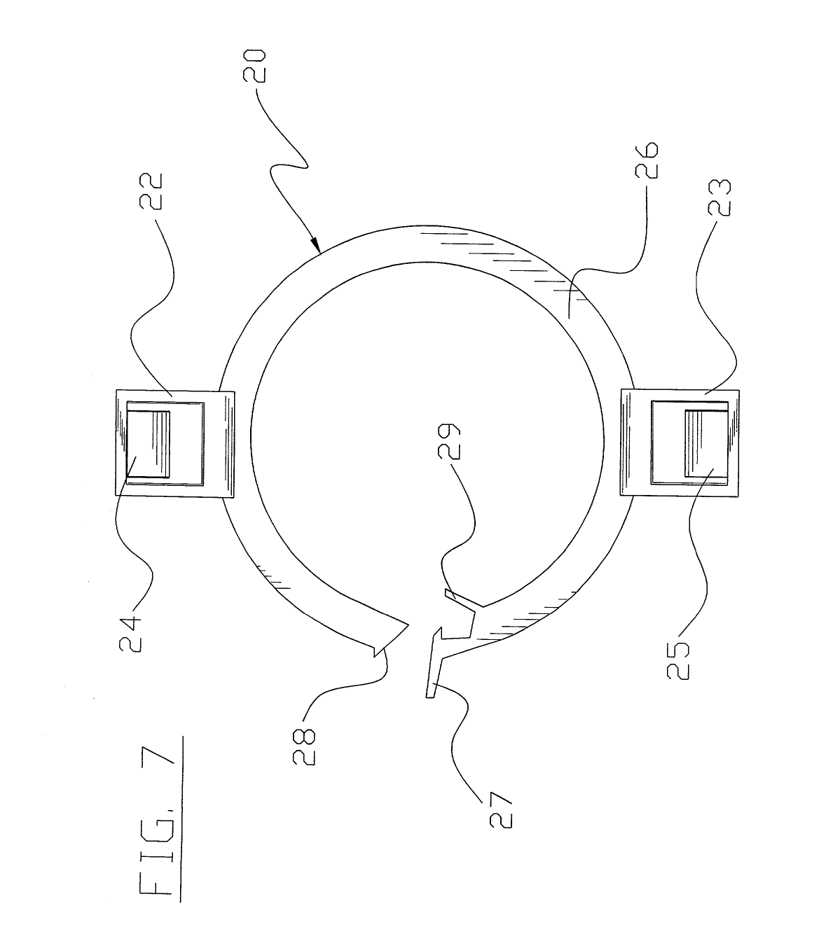

As shown in FIG. 7 of the drawings, a third head 23 is attached to the first body 26 of the first clamp 20 and the second body of the second clamp 30 for allowing for the attachment of a second cable tie 40. The third head 23 is preferably positioned opposite of the first head 22 as shown in FIG. 7 of the drawings though various other positions may be achieved. The third head 23 includes a third receiving slot 25 similar to the first receiving slot 24 within the first head 22.

As with the first clamp 20, the second clamp 30 is comprised of a second body have a looped structure with a center bore for receiving the connector 12, 16 or the cable 14, 18. The second body has a second retaining end and a second handle at a distal end thereof similar to the first clamp 20 that is illustrated in FIGS. 5 through 7 of the drawings. The second body includes second end opposite of the second retaining end. The second retaining end and second handle are formed for catchably receiving the second end. The second handle allows for the connecting and the separation of the second retaining end and the second end. A second head 32 is attached to the second body for receiving the cable tie 40 opposite of the first head 22 of the first clamp 20. The second head 32 includes a second receiving slot formed for catchably receiving the elongate body 44 of the cable tie 40 similar to the first receiving slot 24. The second receiving slot is aligned parallel to the bore within the second body.

The cable tie 40 is best illustrated in FIGS. 1 through 4 of the drawings. The cable tie 40 is comprised of a main head 42 and an elongate body 44 having a plurality of ribs as is commonly found with a conventional cable tie 40. The elongate body 44 is positionable within the receiving slots of the first head 22 and second head 32 of the first clamp 20 and second clamp 30 respectively after the clamps 20, 30 have been secured about the connectors 12, 16. Since cable ties 40 have been in use for years and are readily apparent to one skilled in the art, no further discussion will be made.

In use, the user first snugly connects the first connector 12 with the second connector 16 as shown in FIGS. 1 and 3 of the drawings. The user then positions the first clamp 20 about the second connector 16 as illustrated in FIGS. 1 and 3 of the drawings. The user catchably secures the first end 28 with the first retaining end 29 to retain the first clamp 20 about the second connector 16. The user then positions the second clamp 30 about the first connector 12 as illustrated in FIGS. 1 and 3 of the drawings. The user catchably secures the second end with the second retaining end to retain the second clamp 30 about the first connector 12. The user then inserts the elongate body 44 of the cable tie 40 through the second head 32 of the second clamp 30 and then draws the elongate body 44 through the second head 32 until the main head 42 is adjacent the second head 32. The user then inserts the elongate body 44 through the first head 22 of the first clamp 20 as shown in FIGS. 1 and 3 of the drawings. The user continues to draw the elongate body 44 through the first head 22 until the elongate body 44 is taut between the first clamp 20 and the second clamp 30 for preventing separation or movement of the connectors 12, 16. The first head 22 catchably retains the position of the elongate body 44 within the first receiving slot 24. If the third head 23 of the alternative embodiment is utilized upon the first clamp 20 and the second clamp 30, a second cable tie 40 is inserted through each respective third head 23 as with the first cable tie 40.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A cable connecting system for securely connecting a first connector to a second connector, comprising:
a first clamp positionable about said first connector;
a first head attached to said first clamp;
a second clamp positionable about said second connector;
a second head attached to said second clamp; and
an elongate strap attachable to said first head and said second head for securing said first connector to said second connector.

2. The cable connecting system of claim 1, wherein said first head includes a first receiving slot and wherein said second head includes a second receiving slot for receiving said elongate strap.

3. The cable connecting system of claim 2, wherein said first receiving slot and said second receiving slot catchably receive said elongate strap.

4. The cable connecting system of claim 3, wherein said elongate strap is comprised of a cable tie.

5. The cable connecting system of claim 4, wherein said first clamp has a first bore within and wherein said second clamp has a second bore with in.

6. The cable connecting system of claim 5, wherein said first clamp and said second clamp are each comprised of a body having a first end and a first retaining end for catchably receiving said first end, wherein said body is formed into a looped shape.

7. The cable connecting system of claim 6, wherein said first retaining end includes a handle.

8. The cable connecting system of claim 7, wherein said cable tie includes an elongate body having a main head.

9. The cable connecting system of claim 8, wherein said first receiving slot and said second receiving slot are parallel to a longitudinal axis of said first bore and said second bore respectively.

10. The cable connecting system of claim 9, wherein said first clamp is comprised of a resilient material.

11. A cable connecting system for securely connecting a first connector to a second connector, comprising:
a first clamp positionable about said first connector;
a first head attached to said first clamp;
a second head attached to said first clamp;
a second clamp positionable about said second connector;
a third head attached to said second clamp;
a fourth head attached to said second clamp;
a first elongate strap attachable to said first head and said third head for securing said first connector to said second connector; and
a second elongate strap attachable to said second head and said fourth head for securing said first connector to said second connector;

12. The cable connecting system of claim 11, wherein said first head includes a first receiving slot and said third head includes a third receiving slot for receiving said first elongate strap, and wherein said second head includes a second receiving slot and said fourth head includes a fourth receiving slot for receiving said second elongate strap.

13. The cable connecting system of claim 12, wherein said first receiving slot and said third receiving slot catchably receive said first elongate strap, and wherein said second receiving slot and said fourth receiving slot catchably receive said second elongate strap.

14. The cable connecting system of claim 13, wherein said first elongate strap and said second elongate strap are each comprised of a cable tie.

15. The cable connecting system of claim 14, wherein said first clamp has a first bore within and wherein said second clamp has a second bore within.

16. The cable connecting system of claim 15, wherein said first clamp and said second clamp are each comprised of a body having a first end and a first retaining end for catchably receiving said first end, wherein said body is formed into a looped shape.

17. The cable connecting system of claim 16, wherein said first retaining end includes a handle.

18. The cable connecting system of claim 17, wherein said cable tie includes an elongate body having a main head.

19. The cable connecting system of claim 18, wherein said third head is positioned opposite of said first head, and wherein said fourth head is positioned opposite of said second head.

20. A method of utilizing a cable connecting system having a first clamp, a second clamp and a cable tie for securing a first connector and a second connector together, said method comprising the steps of:
(a) connecting said first connector to said second connector;
(b) positioning said first clamp about said first connector;
(c) securing said first clamp about said first connector;
(d) positioning said second clamp about said second connector;
(e) securing said second clamp about said second connector;
(f) inserting a cable tie through a first head of said first clamp;
(g) drawing said cable tie through said first head;
(h) inserting said cable tie through a second head of said second clamp; and
(i) drawing said cable tie through said second head until taut between said first head and said second head.
